(19) United States
(12) Patent Application Publication
(10) Pub. No.: US 2013/0162612 A1
(43) Pub. Date: Jun. 27, 2013

(54) ELECTRONIC DEVICE AND METHOD FOR SWITCHING BETWEEN FIRST DISPLAY UNIT AND SECOND DISPLAY UNIT

(71) Applicant: Fitipower Integrated Technology, Inc., Hsinchu City (TW)

(72) Inventor: MENG-WEI CHUANG, Hsinchu (TW)

(73) Assignee: FITIPOWER INTEGRATED TECHNOLOGY, INC., Hsinchu City (TW)

(21) Appl. No.: 13/716,395

(22) Filed: Dec. 17, 2012

(30) Foreign Application Priority Data
Dec. 21, 2011 (TW) 100147778

(51) Int. Cl. G09G 3/28

(52) U.S. Cl. CPC G09G 3/28
USPC 345/208; 345/60

(57) ABSTRACT

An electronic device includes a first display unit for displaying static images, a second display unit for displaying dynamic images, a gate driver connected to the first display unit and the second display unit; a source driver connected to the first display unit and the second display unit; a storage unit for storing visual content; and a processor. The processor is operative to determine at least one feature of the visual content; and control the gate driver and the source driver to selectively enable at least one of the first display unit and the second display unit, based on the at least one determined feature, to display the visual content.

### BACKGROUND

1. Technical Field

The disclosed embodiments relate to an electronic device and a method for switching between a first display unit and a second display unit.

2. Description of Related Art

Traditional electronic devices include a single display for outputting visual content. For example, a traditional device may include a liquid crystal display (LCD) or organic light-emitting diode (OLED) display for outputting color visual content. In another example, a traditional device may include an electronic paper display for outputting black-and-white visual content using minimal power. The type of display included in a traditional electronic device is typically based on an assumption about the visual content it will most often display because different types of displays may be optimal, in performance or efficiency, for different types of visual content. For example, an LCD or OLED display may be optimal for high-resolution or dynamic color content while an electronic paper display may be optimal for relatively static black-and-white content.

However, a traditional device may display multiple types of visual content even though its display may only be optimal for a single type of visual content.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout four views.

FIG. 1 is a block diagram of an electronic device in accordance with an embodiment, the electronic device includes a first display unit and a second display unit.

FIG. 2 shows a microcup-based liquid crystal display cell using color filters and a microcup-based electrophoretic display cell.

FIG. 3 is an equivalent circuit diagram showing part of a pixel array in the first display unit and the second display unit shown in FIG. 1.

FIG. 4 is flowchart showing a method for switching between a first display unit and a second display unit in accordance with one embodiment.

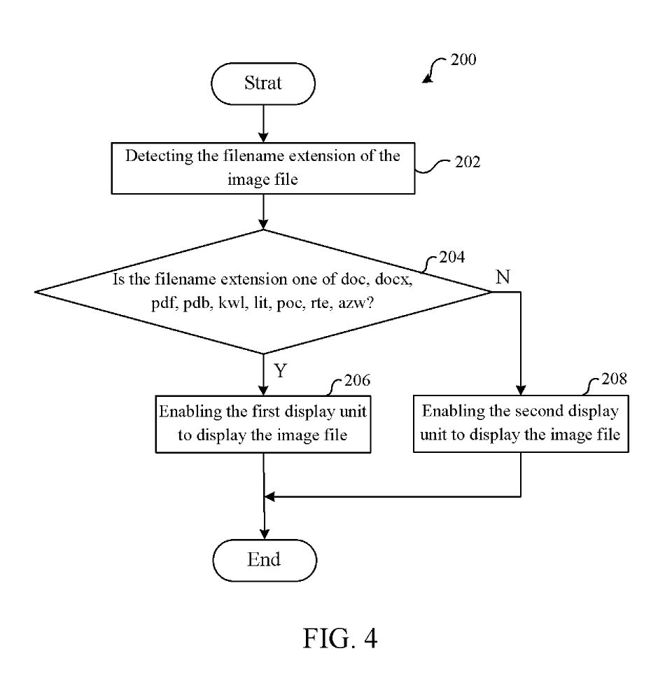

### DETAILED DESCRIPTION

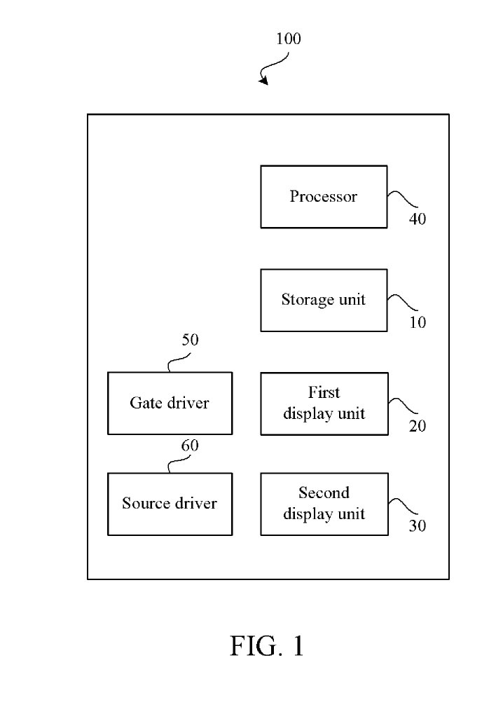

Referring to FIG. 1, an electronic device 100 includes a storage unit 10, a first display unit 20, a second display unit 30, a processor 40, a gate driver 50, and a source driver 60. The storage unit 10 stores visual content.

The first display unit 20 is used for displaying static images, and the second display unit 30 is used for displaying dynamic images. In this embodiment, the first display unit 20 is an electronic paper display (EPD), the second display unit 30 is a liquid crystal display.

The processor 40 determines at least one feature of the visual content, and controls the gate driver 50 and the source driver 60 to selectively drive at least one of the first display unit 20 and the second display unit 30, based on the at least one determined feature, to display the visual content. When the first display unit 20 displays the visual content, the backlight of the second display unit 30 is used as an external light source for illuminating the first display unit 20.

In a first embodiment, the visual content is an image file, the at least one feature of the image file includes a filename extension of the image file; the processor 40 controls the gate driver 50 and the source driver 60 to drive the first display unit 20 to display the image files having the same filename extension as one of doc, docx, pdf, pdb, kwl, lit, poc, rte, azw; and controls the gate driver 50 and the source driver 60 to drive the second display unit 30 to display all other image files not having the same filename extension as one of doc, docx, pdf, pdb, kwl, lit, poc, rte, azw.

In a second embodiment, the at least one feature of the visual content includes a rate of change of the visual content, the processor 40 controls the gate driver 50 and the source driver 60 to drive the first display unit 20 to display the visual content if the rate of change is below a threshold; and controls the gate driver 50 and the source driver 60 to drive the second display unit 30 to display the visual content if the rate of change is above the threshold.

In a third embodiment, the at least one feature of the visual content includes a color composition of the visual content, the processor 40 controls the gate driver 50 and the source driver 60 to drive the first display unit 20 to display the visual content if the color composition is below a threshold; and controls the gate driver 50 and the source driver 60 to drive the second display unit 30 to display the visual content if the color composition is above the threshold.

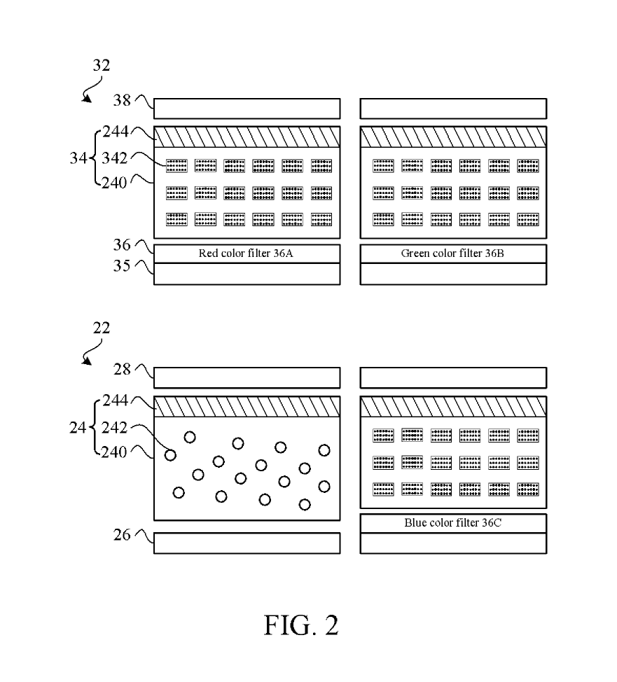

Referring to FIG. 2, in detail, the first display unit 20 includes a plurality of first display cells 22. Each first display cell 22 includes a first microcup 24, a first common electrode 26, and a first pixel electrode 28. The first microcup 24 is formed from a microcup composition 240 and is filled with a first display fluid 242 and a sealing composition 244 that allows the first display fluid 242 to be seamlessly sealed. In this embodiment, the first display fluid 242 is an electrophoretic fluid with a plurality of micro electrophoretic capsules, and the microcup composition 240 and the sealing composition 244 are well-known in the art and are disclosed in U.S. Pat. No. 7,005,468, for clarity, it is not described herein.

Each first microcup 24 is disposed between the first common electrode 26 and the first pixel electrode 28. The first common electrode 26 is transparent, the first pixel electrode 28 is transparent.

The second display unit 30 includes a plurality of second display cells 32. Each second display cell 32 includes a second microcup 34, a second common electrode 35, a color filter 36, and a second pixel electrode 38. The second microcup 34 is formed from the microcup composition 240 and filled with a second display fluid 342 and the sealing composition 244 that allows the second display fluid 342 to be seamlessly sealed. In this embodiment, the second display fluid 342 is a liquid crystal fluid, and the microcup composition 240 and the sealing composition 244 are also disclosed in U.S. Pat. No. 8,023,071, for clarity, it is not described herein.

Each second microcup 34 is disposed between the second common electrode 35 and the second pixel electrode 38, and the color filter 36 is disposed on the second common electrode 35. In this embodiment, the second common electrode 35 and the second pixel electrode 38 are transparent.

The first display cells 22 and the second display cells 32 are arranged in a same layer and are disposed as a matrix. In detail, each first display cell 22 is adjacent to one of the second display cells 32.

Each first microcup 24, a corresponding first common electrode 26 and a corresponding first pixel electrode 28 are defined as an EPD pixel (hereinafter referred as EPD). Each second microcup 34, a corresponding second common electrode 35 and a corresponding second pixel electrode 38 are defined as a LCD pixel. Accordingly, the LCD pixel corresponding to a red color filter 36A is defined as red pixel (hereinafter referred as R), the LCD pixel corresponding to a green color filter 36B is defined as green pixel (hereinafter referred as G), and the LCD pixel corresponding to a blue color filter 36C is defined as blue pixel (hereinafter referred as B).

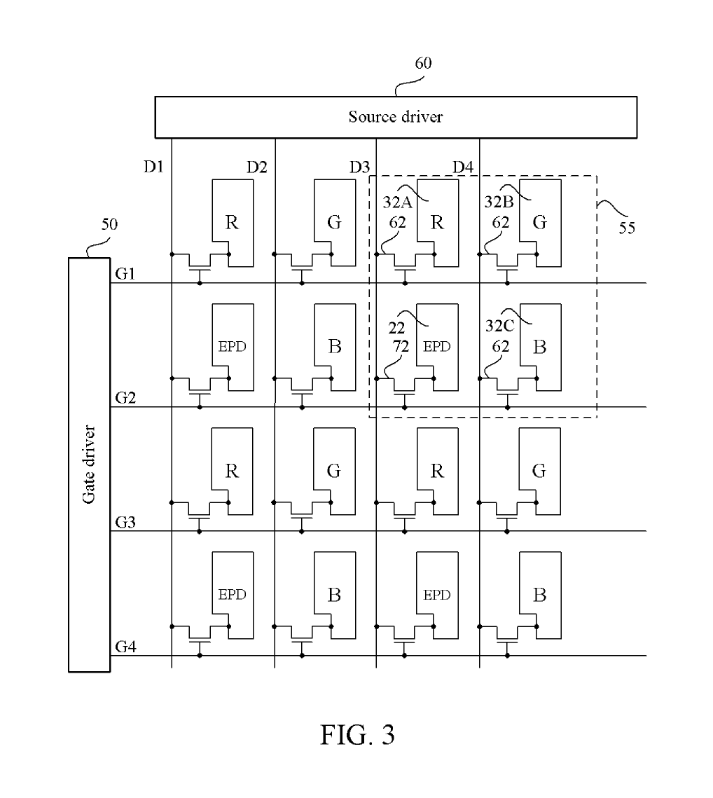

Referring further to FIG. 3, each first display cell 22 further includes a first thin film transistor (TFT) 72, each second display cell 32 further includes a second thin film transistor (TFT) 62. A drain of the first TFT 72 is connected to the first pixel electrode 28, a gate of the first TFT 72 is connected to the gate driver 50, a source of the first TFT 72 is connected to the source driver 60. A drain of the second TFT 62 is connected to the second pixel electrode 38, a gate of the second TFT 62 is connected to the gate driver 50, a source of the second TFT 62 is connected to the source driver 60.

The first display cell 22 and the second display cell 32 are arranged in one of a first form, a second form, a third form, a fourth form, a fifth form, and a sixth form respectively shown below in table 1, table 2, table 3, table 4, table 5 and table 6.

TABLE 1

| | | | |
|---|---|---|---|
| R | G | R | G |
| EPD | B | EPD | B |
| R | G | R | G |
| EPD | B | EPD | B |

TABLE 2

| | | | |
|---|---|---|---|
| R | G | R | G |
| B | EPD | B | EPD |
| R | G | R | G |
| B | EPD | B | EPD |

TABLE 3

| | | | |
|---|---|---|---|
| R | G | B | EPD |
| R | G | B | EPD |
| R | G | B | EPD |
| R | G | B | EPD |

TABLE 4

| | | | |
|---|---|---|---|
| R | G | R | B |
| B | EPD | EPD | G |
| R | EPD | EPD | B |
| G | B | G | R |

TABLE 5

| | | | | | | |
|---|---|---|---|---|---|---|
| R | G | B | EPD | G | B | EPD |
| B | R | G | B | EPD | G | B |
| G | B | R | G | B | EPD | G |
| EPD | G | B | R | G | B | EPD |

TABLE 6

| | | | | | | | | | | |
|---|---|---|---|---|---|---|---|---|---|---|
| R | | G | | B | | R | | G | | B |
| | B | | EPD | | G | | EPD | | R | |
| R | | G | | B | | R | | G | | B |
| | B | | EPD | | G | | EPD | | R | |

In FIG. 3, using the above table 1 as an example. The source driver 60 includes four data lines D1, D2, D3, D4; and the gate driver 50 includes four gate lines G1, G2, G3, G4. The first display unit 20 and the second display unit 30 constitutes a hybrid display unit, the hybrid display unit includes four EPD pixels 22, four red pixels 32A, four green pixels 32B, and four blue pixels 32C which form 4*4 pixel array, each pixel of the hybrid display unit includes the EPD pixel 22, the red pixel 32A, the green pixel 32B, and the blue pixel 32C.

The second display unit 30 further includes four first thin film transistors (TFTs) 72 respectively corresponding to the four EPD pixels 22; and the first display unit 20 further includes twelve second thin film transistors (TFTs) 62 respectively corresponding to four red pixels 32A, four green pixels 32B, and four blue pixels 32C. A first pixel electrode 28 of each EPD pixel 22 is connected to a drain of corresponding first TFT 72, a gate of each first TFT 72 is connected to the gate driver 50, a source of each first TFT 72 is connected to the source driver 60. A second pixel electrode 38 of each red pixel 32A is connected to a drain of corresponding second TFT 62, a second pixel electrode 38 of each green pixel 32B is connected to a drain of corresponding second TFT 62, a second pixel electrode 38 of each blue pixel 32C is connected to a drain of corresponding second TFT 62, a gate of each second TFT 62 is connected to the gate driver 50, a source of each second TFT 62 is connected to the source driver 60.

Taking a pixel 55 of the hybrid display unit for example, the pixel 55 includes the red pixel 32A, the green pixel 32B, the EPD pixel 22, and the blue pixel 32C; a first pixel electrode 28 of the EPD pixel 22 is connected to the drain of corresponding first TFT 72, the gate of the first TFT 72 is connected to the gate line G2 of the gate driver 50, and the source of the first TFT 72 is connected to the data line D3 of the source driver 60. A second pixel electrode 38 of the red pixel 32A is connected to the drain of corresponding second TFT 62, the gate of the second TFT 62 is connected to gate line G1 of the gate driver 50, and the source of the second TFT 62 is connected to the data line D3 of the source driver 60. A second pixel electrode 38 of the green pixel 32B is connected to the drain of corresponding second TFT 62, the gate of the second TFT 62 is connected to gate line G1 of the gate driver 50, and the source of the second TFT 62 is connected to the data line D4 of the source driver 60. A second pixel electrode 38 of the blue pixel 32C is connected to the drain of corresponding second TFT 62, the gate of the second TFT 62 is connected to gate line G2 of the gate driver 50, and the source of the second TFT 62 is connected to the data line D4 of the source driver 60.

FIG. 3, illustrates a method 200 for switching between the first display unit 20 and the second display unit 30 in accordance with a first embodiment. The gate driver 50 and the source driver 60 are provided to drive the first display unit 20, and are also provided to drive the second display unit 30. The storage unit 10 is provided to store visual content. The method 200 is implemented by the electronic device 100, in this embodiment, the visual content is the image file, the method 200 includes the following steps.

Step 202, the processor 40 detects the filename extension of the image file.

Step 204, the processor 40 determines whether the filename extension is one of doc, docx, pdf, pdb, kwl, lit, poc, rte, azw; if it is determined that the filename extension is one of doc, docx, pdf, pdb, kwl, lit, poc, rte, azw, the process goes to step 206; if it is determined that the filename extension is not one of doc, docx, pdf, pdb, kwl, lit, poc, rte, azw, the process goes to step 208.

Step 206, the processor 40 controls the gate driver 50 and the source driver 60 to drive the first display unit 20 to display the image files.

Step 208, the processor 40 controls the gate driver 50 and the source driver 60 to drive the second display unit 30 to display all other image files.

In a second embodiment, the processor 40 detects a rate of change of the visual content, therefore step 206 is replaced by the step of controlling the gate driver 50 and the source driver 60 to drive the first display unit 20 to display the visual content if the rate of change is below a threshold; and step 208 is replaced by the step of controlling the gate driver 50 and the source driver 60 to drive the second display unit 30 to display the visual content if the rate of change is above the threshold.

In a third embodiment, the processor 40 detects a color composition of the visual content, therefore step 206 is replaced by the step of controlling the gate driver 50 and the source driver 60 to drive the first display unit 20 to display the visual content if the color composition is below a threshold; and step 208 is replaced by the step of controlling the gate driver 50 and the source driver 60 to drive the second display unit 30 to display the visual content if the color composition is above the threshold.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a first display unit for displaying static images, the first display unit comprising a plurality of first display cells, each first display cell comprising a first microcup formed from a microcup composition and filled with a first display fluid and a sealing composition that allows the first display fluid to be seamlessly sealed; and
a second display unit for displaying dynamic images, the second display unit comprising a plurality of second display cells, each second display cell comprising a second microcup formed from the microcup composition and filled with a second display fluid and the sealing composition that allows the second display fluid to be seamlessly sealed, wherein the first display cells and the second display cells are arranged in a same layer and are disposed as a matrix.

2. The electronic device of claim 1, wherein each first display cell is adjacent to one of the second display cells.

3. The electronic device of claim 1, wherein each first display cell further comprises a first common electrode and a first pixel electrode, the first microcup is disposed between the first common electrode and the first pixel electrode; each second display cell further comprises a second common electrode, a second pixel electrode, and a color filter, the second microcup is disposed between the second common electrode and the second pixel electrode, and the color filter is disposed on the second common electrode.

4. The electronic device of claim 3, wherein the first common electrode, the second common electrode, the first pixel electrode, and the second pixel electrode are transparent.

5. The electronic device of claim 1, further comprising:
a gate driver connected to the first display unit and the second display unit;
a source driver connected to the first display unit and the second display unit;
a processor; and
a storage unit for storing visual content; wherein the processor is operative to:
determine at least one feature of the visual content; and
control the gate driver and the source driver to selectively enable at least one of the first display unit and the second display unit, based on the at least one determined feature, to display the visual content.

6. The electronic device of claim 5, wherein the visual content is an image file, the at least one feature of the image file comprises a filename extension of the image file, and the processor is operative to:
control the gate driver and the source driver to enable the first display unit to display the image files having the same filename extension as one of doc, docx, pdf, pdb, kwl, lit, poc, rte, azw; and
control the gate driver and the source driver to enable the second display unit to display all other image files not having the same filename extension as one of doc, docx, pdf, pdb, kwl, lit, poc, rte, azw.

7. The electronic device of claim 5, wherein the at least one feature of the visual content comprises a rate of change of the visual content, and the processor is operative to:
control the gate driver and the source driver to enable the first display unit to display the visual content when the rate of change is below a threshold; and
control the gate driver and the source driver to enable the second display unit to display the visual content when the rate of change is above the threshold.

8. The electronic device of claim 5, wherein the at least one feature of the visual content comprises a color composition of the visual content, and the processor is operative to:
control the gate driver and the source driver to enable the first display unit to display the visual content when the color composition is below a threshold; and
control the gate driver and the source driver to enable the second display unit to display the visual content when the color composition is above the threshold.

9. The electronic device of claim 5, wherein when the first display unit displays the visual content, the backlight of the second display unit is used as an external light source for illuminating the first display unit.

10. The electronic device of claim 3, further comprising:
a gate driver; and
a source driver;
wherein each first display cell further comprises a first thin film transistor (TFT), each second display cell further comprises a second thin film transistor (TFT); a drain of the first TFT is connected to the first pixel electrode, a gate of the first TFT is connected to the gate driver, a source of the first TFT is connected to the source driver; a drain of the second TFT is connected to the second pixel electrode, a gate of the second TFT is connected to the gate driver, a source of the second TFT is connected to the source driver.

11. The electronic device of claim 10, wherein the first display unit is an electronic paper display (EPD) unit, the first display fluid is an electrophoretic fluid with a plurality of micro electrophoretic capsules; the second display unit is a liquid crystal display unit, the second display fluid is a liquid crystal fluid; the first display cell is defined as an EPD pixel (hereinafter referred as EPD), the second display cell with a red color filter is defined as a red pixel (hereinafter referred as R), the second display cell with a green color filter is defined as a green pixel (hereinafter referred as G), the second display cell with a blue color filter is defined as a blue pixel (hereinafter referred as B); the first display cell and the second display cell are arranged in one of a first form, a second form, a third form, a fourth form, a fifth form, and a sixth form respectively shown below in table 1, table 2, table 3, table 4, table 5 and table 6:
TABLE 1

| | | | |
|---|---|---|---|
| R | G | R | G |
| EPD | B | EPD | B |
| R | G | R | G |
| EPD | B | EPD | B |

TABLE 2

| | | | |
|---|---|---|---|
| R | G | R | G |
| B | EPD | B | EPD |
| R | G | R | G |
| B | EPD | B | EPD |

TABLE 3

| | | | |
|---|---|---|---|
| R | G | B | EPD |
| R | G | B | EPD |
| R | G | B | EPD |
| R | G | B | EPD |

TABLE 4

| | | | |
|---|---|---|---|
| R | G | R | B |
| B | EPD | EPD | G |
| R | EPD | EPD | B |
| G | B | G | R |

TABLE 5

| | | | | | | |
|---|---|---|---|---|---|---|
| R | G | B | EPD | G | B | EPD |
| B | R | G | B | EPD | G | B |
| G | B | R | G | B | EPD | G |
| EPD | G | B | R | G | B | EPD |

TABLE 6

| | | | | | | | | | | |
|---|---|---|---|---|---|---|---|---|---|---|
| R | | G | | B | | R | | G | | B |
| | B | | EPD | | G | | EPD | | R | |
| R | | G | | B | | R | | G | | B |
| | B | | EPD | | G | | EPD | | R | |

12. A method for switching between a first display unit and a second display unit, the first display unit for displaying static images, the first display unit comprising a plurality of first display cells, each first display cell comprises a first microcup formed from a microcup composition and filled with a first display fluid and a sealing composition that allows the first display fluid to be seamlessly sealed; a second display unit for displaying dynamic images, the second display unit comprising a plurality of second display cells, each second display cell comprises a second microcup formed from the microcup composition and filled with a second display fluid and the sealing composition that allows the second display fluid to be seamlessly sealed, the first display cells and the second display cells arranged in a same layer and disposed as a matrix, the method comprising the steps of:
providing a storage unit for storing visual content;
determining at least one feature of the visual content; and
selectively enabling at least one of the first display unit and the second display unit, based on the at least one determined feature, to display the visual content.

13. The method of claim 12, further comprising the steps of:
providing a source driver and a gate driver; wherein the first display unit is driven by the source driver and the gate driver; and the second display unit is also driven by the source driver and the gate driver.

14. The method of claim 13, wherein the visual content is an image file, the at least one feature of the image file comprises a filename extension of the image file, the step of “selectively enable at least one of the first display unit and the second display unit” comprises the sub-steps of:
controlling the source driver and the gate driver to enable the first display unit to display the image files having the same filename extension as one of doc, docx, pdf, pdb, kwl, lit, poc, rte, azw; and
controlling the source driver and the gate driver to enable the second display unit to display all other image files not having the same filename extension as one of doc, docx, pdf, pdb, kwl, lit, poc, rte, azw.

15. The method of claim 13, wherein the at least one feature of the visual content comprises a rate of change of the visual content, the step of “selectively enable at least one of the first display unit and the second display unit” comprises the sub-steps of:
controlling the source driver and the gate driver to enable the first display unit to display the visual content when the rate of change is below a threshold; and
controlling the source driver and the gate driver to enable the second display unit to display the visual content when the rate of change is above the threshold.

16. The method of claim 13, wherein the at least one feature of the visual content comprises a color composition of the visual content, the step of “selectively enable at least one of the first display unit and the second display unit” comprises the sub-steps of:
controlling the source driver and the gate driver to enable the first display unit to display the visual content when the color composition is below a threshold; and
controlling the source driver and the gate driver to enable the second display unit to display the visual content when the color composition is above the threshold.

17. The method of claim 12, wherein the first display unit is an electronic paper display (EPD) unit, the first display fluid is an electrophoretic fluid with a plurality of micro electrophetic capsules; the second display unit is a liquid crystal display unit, the second display fluid is a liquid crystal fluid; when the first display unit displays the visual content, the backlight of the second display unit is used as an external light source for illuminating the first display unit.

18. An electronic device, comprising:
a first display unit for displaying static images;
a second display unit for displaying dynamic images;
a gate driver connected to the first display unit and the second display unit;
a source driver connected to the first display unit and the second display unit;
a storage unit for storing visual content; and
a processor; wherein the processor is operative to:
determine at least one feature of the visual content; and
control the gate driver and the source driver to selectively enable at least one of the first display unit and the second display unit, based on the at least one determined feature, to display the visual content.
